(19) United States
(12) Patent Application Publication
(10) Pub. No.: US 2026/0309533 A1
(43) Pub. Date: Oct. 8, 2026

(54) MEASURING DEVICE FOR AUTONOMOUS AND WIRELESS DETECTION OF FLUID MEDIA IN AN ENVIRONMENT

(71) Applicant: ArianeGroup GmbH, TAUFKIRCHEN (DE)

(72) Inventors: Christian HESSEL, BREMEN (DE); Johannes SEBALD, BREMEN (DE); Christoph JURCZYK, BREMEN (DE)

(21) Appl. No.: 19/482,043

(22) PCT Filed: Apr. 17, 2024
(86) PCT No.: PCT/EP2024/060394

§ 371 Date: Nov. 6, 2025

(30) Foreign Application Priority Data
May 12, 2023 (EP) 23173105.0

(51) Int. Cl. G01F 23/26; G01F 23/296

(52) U.S. Cl. CPC G01F 23/26; G01F 23/2961

(57) ABSTRACT

A measuring device for a fluid medium in an environment comprising at least two electrodes, arranged in the environment and spaced from one another. The electrodes measure an electrical capacitance in the space between them. The device also has a surface acoustic wave sensor, an electrically non-conductive support layer, an antenna and an interrogator. A wireless request signal from the interrogator is transmitted the antenna to the surface acoustic wave sensor, the surface acoustic wave sensor is excited by the request signal and a response signal sent back. The response signal is evaluated in order to measure the electrical capacitance between the electrodes and from that to ascertain at least one property of the fluid medium inside the environment.

### CROSS-REFERENCES TO RELATED APPLICATIONS

This application claims the benefit of International Application Number PCT/EP2024/060394 filed on Apr. 17, 2024, and of the European patent application No. 23173105.0 filed on May 12, 2023, the entire disclosures of which is incorporated herein by way of reference.

### FIELD OF THE INVENTION

The present invention relates to a measuring device for detecting at least one property of a fluid medium in an environment according to the preamble of Patent Claim 1, comprising at least two electrodes, which are arranged in the environment and spaced from one another, which electrodes are set up to measure an electrical capacitance in the intermediate space between them.

### BACKGROUND OF THE INVENTION

In a known measuring device, fill level sensors for measuring the capacitance on the inside of a tank are electrically connected to the electrodes for measuring a property of a fluid medium, for example the fill level in the tank, and connected by at least two coaxial connections through openings in the wall of the tank to an external measuring amplifier outside the tank. As a result, for example for five sensors in each case having two electrodes, ten coaxial connections and therefore ten openings or one correspondingly large opening are required in the wall of the tank. These coaxial connections are for the most part realized by gas-tight feed-throughs through the tank capsule using special plugs. On the one hand, these plugs must be suitable for the low electrical signals for measuring the capacitance and on the other hand, it must be possible to use them in a demanding temperature environment with high mechanical loads, such as vibration and mechanical shocks. A further important aspect is the tightness at the feed-through openings for the coaxial connections. An important basic requirement for the safe operation of a tank for a fluid medium, for example a tank with liquid cryogenic propellant for a launch vehicle, is the tightness of these feed-through openings. Due to the passing through of the electrical signals, the structural capsule of the tank is broken through, as a result of which reliable sealing of the electrical feed-through openings is necessary. With the use of liquid hydrogen as propellant for launch vehicles, realizing such sealing represents a challenge due to the small molecule size of hydrogen.

An object of the present invention is therefore to provide a measuring device which enables a reliable measurement of a property or a state of a medium in an environment and sufficient sealing of an environment capsule which delimits the environment.

### SUMMARY OF THE INVENTION

This object may be achieved by a measuring device having the features of one or more embodiments described herein.

The invention relates to a measuring device for a fluid medium in an environment, comprising at least two electrodes, which are arranged in the environment and spaced from one another, which electrodes are set up to measure an electrical capacitance in the intermediate space between them. The measuring device in this case additionally comprises at least one surface acoustic wave (SAW) sensor, an electrically non-conductive support layer, at least one antenna and at least one interrogator, wherein the electrodes are attached on the non-conductive support layer. The two electrodes are electrically connected to the surface acoustic wave sensor, wherein the antenna is arranged inside the environment and is electrically connected to the interrogator outside the environment by means of an electrical connection through a feed-through opening through an environment capsule. A wireless request signal from the interrogator can be transmitted by means of the antenna to the surface acoustic wave sensor. The surface acoustic wave sensor can be excited by the request signal and a wireless response signal can be received and transmitted to the interrogator by means of the antenna. The response signal can be evaluated by means of the interrogator in order to measure the electrical capacitance between the electrodes and from that to ascertain at least one property of the fluid medium inside the environment.

An environment can for example be a tank such as a propellant tank or a pipe segment of a fluid distribution system for example. Another term for environment is balance space. Properties to be detected can for example be a fill level, a distribution of the fluid medium in the environment, a portion of the fluid medium in the environment, the type of the fluid medium, a temperature of the fluid medium, a flow direction, a flow velocity and the like. The detection takes place directly, i.e. wirelessly and preferably also autonomously.

The present measuring device uses at least one surface acoustic wave (SAW) sensor. Surface acoustic wave (SAW) sensors are passive wireless sensors which convert electromagnetic waves of a request signal into surface acoustic waves by means of an interdigital transducer (IDT)=antenna using piezoelectric substrates, which surface acoustic waves are then manipulated by the physical variable that is to be measured. The manipulated surface acoustic waves are again converted into an electromagnetic response signal by the IDT and emitted. This response signal can be received and measured and the value of the electrical capacitance of the fluid medium can be determined from the changed response signal.

In principle, two principles are used for manipulating the surface acoustic wave by means of the measured variable:

The surface acoustic wave sensor can for example be a resonator type surface acoustic wave (SAW) sensor which uses the excitement of a resonance with corresponding resonant frequency, which is generated by the request signal on the sensor. As soon as one switches off the request signal, the surface acoustic wave sensor sends a fading response signal with a particular resonant frequency. This resonant frequency depends among other things on the measured variable, electrical capacitance in the present case.

The surface sensor can for example be a delay line type surface acoustic wave (SAW) sensor which uses the change in the velocity of the surface acoustic wave or the path travelled by the surface acoustic wave. To this end, reflectors are used in the SAW sensors, which reflect the acoustic surface after the receipt of the excitation signal and send it back to the IDT. The instant of reflection depends on the physical position of the reflector, which for this type is changed inter alia by the measured variable, electrical capacitance of the fluid medium in the present case.

By determining the time difference of the excitation signal and response signal (due to the reflection), it is possible to determine the measured variable.

The excitation due to the request signal and interpretation of the response signal is carried out by a so-called interrogator. This sends an electromagnetic request signal with a particular frequency spectrum and power spectrum and receives the low power response signals of at least one surface acoustic wave sensor by means of the antenna.

Measured variables can thus typically be measured up to a distance for example of approximately 10 m between sensor and interrogator without any cable connections.

The at least one surface acoustic wave sensor in this case operates completely passively (purely mechanical structure without electronic components) and without requiring a local energy supply, such as a battery for example. This makes it possible to use the at least one surface acoustic wave sensor in demanding environments, such as at low temperatures, high accelerations, and environments with ionizing radiation. Therefore, the present measuring device is suitable in particular for measuring a fluid medium, such as a fluid propellant for example, in a tank of a launch vehicle.

The fluid medium can be a cryogenic liquid propellant for a launch vehicle, such as LOX or LH2, wherein this fluid medium influences the electrical capacitance inside the tank during filling due to the change of the dielectric constant of the fluid medium, so for example the fill level of the tank can be determined by means of the measurement of the electrical capacitance of the at least one surface acoustic wave sensor.

The external interrogator can comprise a measuring amplifier and/or measuring transformer which converts the low response signals into a sufficiently large voltage signal on the basis of the electrical capacitance values, which voltage signal can then be acquired from the controller of the launch vehicle and used for example to ascertain the fill level of the launch vehicle.

The non-conductive support layer can be produced from any desired electrically insulating material, for example from Kapton or a glass fiber layer.

The electrical connection through the feed-through opening in the environment capsule can be provided with a seal which is suitable for sealing the fluid medium inside the environment, such as a cryogenic fluid propellant for a launch vehicle at low temperatures and high pressure.

The wireless request signal is consequently transmitted by the interrogator by means of the antenna to the surface sensor which is excited thereby and sends back a wireless response signal to the interrogator by means of the antenna, wherein the response signal is evaluated by means of the interrogator in order to measure the capacitance between the electrodes and derive the fill level inside the environment for example therefrom.

The ascertainment of the at least one property of the fluid medium in its environment, such as the fill level inside a tank on the basis of the measured electrical capacitance between respective electrodes, can take place by means of the interrogator or else by means of a separate evaluation unit.

The evaluation unit can be realized in the form of an electronic circuit or a programmable computer which is suitable for evaluating the response signals of the surface acoustic wave sensors, determining the electrical capacitance therefrom and consequently ascertaining the at least one property of the fluid medium in its environment.

The electrodes can be attached on the inside of the tank or else on internal structures of the tank, such as for example baffle plates for avoiding eddying inside the tank.

One advantage of the measuring device consists in it being possible to use a surface acoustic wave sensor for measuring the fill level in demanding environments, such as low temperatures, high acceleration, high mechanical load and ionizing radiation, so that this measuring device is suitable in particular for measuring at least one property or a state of a fluid medium in an environment of a launch vehicle, for example for detecting the fill level of a tank of a launch vehicle.

A further advantage of the measuring device consists in only a single feed-through opening with the electrical connection between the antenna and the interrogator being required, since the antenna is arranged in the interior of the tank and excites the at least one surface acoustic wave sensor by means of the request signal. The surface acoustic wave sensor or a plurality of these surface acoustic wave sensors are consequently excited wirelessly and do not require their own electrical connection to the outside of the tank capsule. As a result, the tightness of the tank is consequently improved in the case of a fluid medium in particular, such as liquid hydrogen owing to the small molecule size.

A further advantage of the measuring device consists in it being possible to choose the position, the number and the size of the surface acoustic wave sensors in a variable manner, since no cables are required for electrically connecting these surface acoustic wave sensors to the outside of the tank capsule and consequently no further feed-through openings are required. A high number of surface acoustic wave sensors enables a correspondingly high measurement resolution of the electrical capacitance tomography inside the tank, in order for example to determine the fill level in different regions of the internal volume of the tank or for example a distribution of the fluid medium in the environment.

A further advantage of the measuring device consists in it being possible to integrate the passive surface acoustic wave sensors that are used in the inside of the environment already during production, for example by functional printing, so that as a result, the production duration and the quality of the mode of operation of the surface acoustic wave sensors and the electrical connections inside the tank are improved.

Advantageously, a plurality of surface acoustic wave sensors with in each case a pair of electrodes can be attached on the non-conductive support layer on the inside of the tank, wherein each of the surface acoustic wave sensors can be excited by the wireless request signal by means of the antenna and each of the surface acoustic wave sensors transmits a wireless response signal back to the antenna and further to the interrogator, wherein the response signals of the respective surface acoustic wave sensors can be evaluated by means of the interrogator or a separate evaluation unit, in order for example to ascertain the fill level inside the tank.

As a result, a pair of electrodes on the inside of the environment is connected to each of the surface acoustic wave sensors, so that the measurement of the electrical capacitance is enabled in different regions of the internal volume of the environment and thus the measurement of the fill level is enabled for example inside the environment in different regions. In the case of cryogenic fluid medium in particular, such as liquid propellant LOX or LH2 for launch vehicles, which are partially liquid and partially gaseous, the measurement of the fill level in a plurality of regions of the internal volume of the environment is particularly advantageous. A topography of the fill level can for example be ascertained from the individual measurements in order to be able to make a better statement about the fill level of the launch vehicles.

Advantageously, the pairs of electrodes for each of the surface acoustic wave sensors can be arranged at a particular specified fill height of the tank, wherein the response signals of the respective surface acoustic wave sensors can be evaluated by means of the interrogator or the separate evaluation unit in order to ascertain the at least one property, such as the fill level at the specified fill height of the tank.

As a result, the electrical capacitance is measured at a particular specified height in a plurality of regions of the internal volume of the tank, so that the fill height can be ascertained for various regions at this specified height.

Advantageously, at least two pairs of electrodes for the surface acoustic wave sensors can be arranged at least at two different specified fill heights of the tank, in order to ascertain the fill level at a plurality of specified fill heights.

As a result, the measurement of the electrical capacitance at different fill heights of the tank is enabled, so that the fill level can be ascertained at different heights of the tank.

Advantageously, a plurality of pairs of electrodes for the respective surface acoustic wave sensors can be arranged at each of the at least two different specified fill heights of the tank.

As a result, the measurement of the electrical capacitance is enabled at different fill heights of the tank in different regions of the internal volume of the tank, so that a more accurate ascertainment of a topography of the fill level in the internal volume of the tank is enabled.

A further subject matter of the invention is a measuring method for measuring at least one property of a fluid medium in an environment, for example the fill level in a tank, by means of the above-mentioned measuring device, wherein the wireless request signal is transmitted from the interrogator to the surface acoustic wave sensor by means of the antenna. The surface acoustic wave sensor is excited by the request signal, the wireless response signal is received and transmitted to the interrogator by means of the antenna. The response signal is evaluated by means of the interrogator or a separate evaluation unit, in order to ascertain the property of the fluid medium inside the environment.

One advantage of this measuring method consists in wirelessly exciting the surface acoustic wave sensors by means of the request signal of the interrogator and wirelessly transmitting the response signal back to the interrogator by means of the antenna, so that any desired number of surface acoustic wave sensors can be arranged at any desired positions inside the tank, in order to ascertain the fill level in the internal volume of the tank for various regions.

Advantageously, a plurality of pairs of electrodes for each of the surface acoustic wave sensors can be arranged at a particular specified fill height of the tank, wherein the response signals of the respective surface acoustic wave sensors are evaluated by means of the interrogator or a separate evaluation unit in order to ascertain the fill level at the specified fill height of the tank.

As a result, the electrical capacitance and consequently the fill level for various regions of the internal volume of the tank can be measured at a specified fill height.

Advantageously, at least two pairs of electrodes for the surface acoustic wave sensors can be arranged at least at two different specified fill heights of the tank, wherein the response signals of the respective surface acoustic wave sensors are evaluated by means of the interrogator or the separate evaluation unit in order to ascertain the fill level at a plurality of specified fill heights.

As a result, the electrical capacitance and consequently the fill level can be ascertained at a plurality of specified fill heights.

Advantageously, the response signal can be influenced by a capacitance value between the electrodes of the at least one surface acoustic wave sensor, so that during filling of the environment, the capacitance value between the electrodes is changed by a dielectric constant of the fluid medium that is different compared to gas located in the environment and consequently, the change of the response signal is evaluated by means of the interrogator or the separate evaluation unit in order to detect the at least one property, such as the fill level.

The gas in the environment may be air, propellant gas, such as hydrogen, or else a gas mixture of air with the propellant gas. The electrical capacitance of the gas in the environment can likewise be measured using the measuring device. When filling the tank, the electrical capacitance between the respective pairs of electrodes is therefore changed owing to the different dielectric constant of the fluid medium, so that as a result, the exemplary ascertainment of the fill level is enabled.

A further subject matter of this invention is a production method of the above-explained measuring device. The at least one surface acoustic wave sensor and the at least two electrodes are applied, for example by lamination, in the form of at least one prefabricated integrated sensor band on the electrically non-conductive support layer, for example made of Kapton.

One example of this production method is that by using a prefabricated sensor band comprising the surface acoustic wave sensor and the two electrodes and also the electrical connections therebetween, the production duration is shortened and the complexity of the assembly inside the tank is improved.

The application of the electrically non-conductive support layer can for example likewise take place by laminating on a film made of Kapton.

The lamination on the one hand refers to a materially connected, thermal joining method without auxiliary materials. On the other hand, this means the connection of a thin, often film-like layer to a support material by means of an adhesive and also the connection of at least two film layers of a thermoplastic by reaching the glass transition temperature and a corresponding pressure.

Advantageously, a plurality of integrated fill level sensor bands can be attached at different fill heights on the inner wall or the inside of the tank in order to ascertain the fill level inside the tank for various fill heights.

By applying the integrated fill level sensor bands at different fill heights for example by lamination, the production duration is shortened and possible assembly errors are avoided.

Advantageously, the at least one surface acoustic wave sensor, the support layer and the at least two electrodes can be printed directly on the internal wall of the tank automatically by means of a printing method, such as functional printing.

In functional printing (function integration by printing technology) classic electrical components, such as sensors are automatically applied to a surface. In this case, electrically conductive paste is applied to a surface using a digital and mask-based printing technology. By means of the printing of various geometric shapes, different sensors, in the present case surface acoustic wave sensors, can be realized. By means of the functional printing, not only can two-dimensional surfaces be printed on, rather the printing paste can be applied on a three-dimensionally curved surface using multi-axis installations (e.g. industrial robots). By means of the functional printing, the piezo elements are consequently printed of piezoelectric substrates and the electrically conductive elements of the surface acoustic wave sensor and also the electrodes are printed of an electrically conductive paste.

By means of the use of the functional printing, the production of the surface acoustic wave sensors and the attachment of a support layer are consequently automated and consequently the production duration is shortened and the complexity is simplified, since manual attachment and therefore possible errors are avoided.

Advantageously, the electrically non-conductive support layer can be applied by a surface treatment by means of plasma, by laminating on a film made of Kapton or by laminating on a glass fiber layer.

The surface is thoroughly cleaned by the surface treatment by means of plasma and the adhesion for the subsequent lamination is improved.

As a result, the production of the electrically non-conductive support layer is automated and consequently the production duration is shortened.

Advantageously, a piezoelectric layer for the surface acoustic wave sensor can be applied onto the non-conductive support layer and polarized by means of a dispenser by means of a multi-axis installation, such as an industrial robot, wherein an interdigital transducer (IDT) and/or reflectors of the surface acoustic wave sensor and also the electrodes are subsequently applied to the support layer by means of a conductive paste.

An industrial robot with a dispenser or dosing device enables the automated and controlled dosing of materials onto a workpiece, wherein the dosing process can be controlled in a reliable and exceptionally accurately repeatable manner.

Due to the use of such an industrial robot, a fully automatic production and integration of the surface acoustic wave sensors is enabled inside the tank.

A further subject matter of this invention is an environment, for example a propellant tank, preferably for a spacecraft or a launch vehicle, having the above-5446.163135 described measuring device and/or for applying the above-described measuring method and/or produced according to the above-described production method.

One advantage of this environment with the described measuring device, produced according to the described production method would be particularly suitable for a launch vehicle, since the measurement of the electrical capacitance inside the environment of the launch vehicle is ensured even in the case of high temperature fluctuations, high mechanical loads and also high acceleration.

### BRIEF DESCRIPTION OF THE DRAWINGS

Preferred exemplary embodiments of the invention are explained below with reference to greatly simplified schematic drawings. In the figures:

FIG. 1 shows a schematic illustration of the measuring device having a plurality of surface acoustic wave sensors;

FIG. 2 shows a schematic illustration for explaining the mode of operation of a surface acoustic wave sensor with capacitive coupling;

FIG. 3 shows a schematic illustration of a preintegrated sensor band;

FIG. 4 shows a schematic illustration of a sensor band which is attached on the inside of an environment; and

FIG. 5 shows a schematic illustration for explaining a production method by means of an industrial robot.

### DETAILED DESCRIPTION OF THE PREFERRED EMBODIMENTS

The measuring device according to the invention is described in the exemplary embodiments as a measuring device for direct (wireless and autonomous) measurement of a fill level of a fluid medium in a tank. It is explicitly pointed out that this measuring device according to the invention is not limited to the detection of a fill level of a fluid medium in a tank however. The illustration as a fill level measuring device is purely exemplary. The illustration of the tank is likewise purely exemplary. By means of the measuring device according to the invention, generally at least one property/at least one state of a fluid medium in an environment or a balance space can be detected directly. In addition to the quantitative property fill level (quantity) and distribution, qualitative properties of the fluid medium in the environment can also be detected, such as for example the type of the medium, temperature, direction of flow and flow velocity. Exemplary environments besides a propellant tank are tanks in general and pipelines, for example of a fluid distribution system.

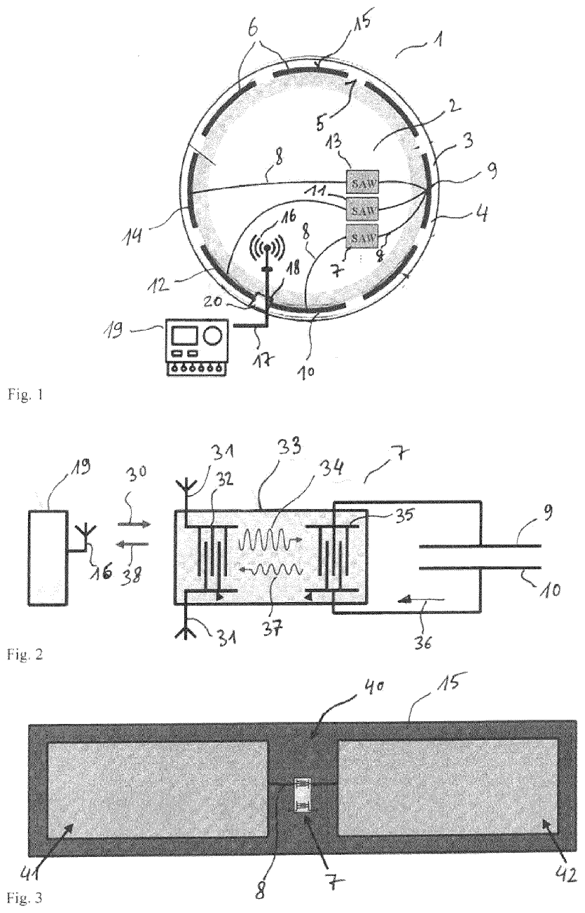

FIG. 1 shows a schematic illustration of the measuring device 1 for a fluid medium 2, such as propellant, particularly liquid hydrogen, inside an environment such as a tank 3 of a launch vehicle. On an internal wall or inner side 5 of the environment capsule, here the tank capsule 4, a plurality of mutually spaced electrodes 6 are attached, which are set up to measure an electrical capacitance in the intermediate space between the electrodes 6 in the interior of the tank 3 (inside the environment). The measuring device additionally has a first surface acoustic wave sensor 7, which is connected by means of electrical connections 8 to a first electrode 9 and a second electrode 10, so the electrical capacitance in the region between the first electrode 9 and the second electrode 10 is measured by means of the first surface acoustic wave sensor 7. A second surface acoustic wave sensor 11 is electrically connected to the first electrode 9 and a third electrode 12, so the electrical capacitance in the region between the first electrode 9 and the third electrode 12 is measured. A third surface acoustic wave sensor 13 is electrically connected to the first electrode 9 and the fourth electrode 14 by means of the electrical connections 8, so the electrical capacitance in the third region between the first electrode 9 and the fourth electrode 14 is measured by means of the third surface acoustic wave sensor 13. In the same way, further surface acoustic wave sensors can be connected to the remaining electrodes 6, in order to cover further regions of the internal volume of the tank 3. The electrodes 6, 9, 10, 12 and 14 are attached to the internal wall 5 of the tank capsule 4 on a non-conductive support layer 15. An antenna 16 is arranged in the interior of the tank 3 and electrically connected to an interrogator 19 outside the tank 3 by means of an electrical connection 17 through a feed-through opening 18 through the tank capsule 4 of the tank 3. The feed-through opening 18 is in this case sealed using a seal 20, so that the fluid medium 2 cannot force its way to the outside. A wireless request signal from the interrogator 19 is emitted by means of the antenna 16 inside the tank and excites the individual corresponding surface acoustic wave sensors 7, 11, 13 by means of the respective electrode pairs, 6, 9, 10, 12 and 14, wherein these surface acoustic wave sensors transmit a response signal back to the antenna 16 and further to the interrogator 19, which response signal is evaluated to measure the electrical capacitance between the electrodes and from that to ascertain a property or a state of the fluid medium, such as a fill level inside the tank 3.

FIG. 2 shows a schematic illustration for explaining the mode of operation of the surface acoustic wave sensor 7, 11, 13 from FIG. 1. The interrogator 19 sends a wireless request signal 30 by means of the internal antenna 16, as is illustrated by the arrow, which request signal is forwarded by the antennas 31 to an interdigital transducer (IDT) 32, wherein the electromagnetic waves of the request signal 30 are converted into surface acoustic waves 34 of the request signal 30 using a piezoelectric substrate 33. The surface acoustic waves 34 of the request signal 30 are then in turn converted into electromagnetic waves by means of a reflector 35 and forwarded to both electrodes 9 and 10 in each case. A response signal 36 is correspondingly generated, depending on the electrical capacitance between the two electrodes 9 and 10, as is illustrated by the arrow, which response signal is in turn converted by means of the reflector 35 into surface acoustic waves 37 of the response signal 36 using the piezoelectric substrate 33, wherein the surface acoustic waves 37 of the response signal 36 are converted by means of the interdigital transducer (IDT) 32 into electromagnetic waves 38 of the response signal 36 and are transmitted by means of the antennas 31 to the antenna 16 of the interrogator 19. The electromagnetic waves 38 of the response signal 36 are then evaluated by means of the interrogator 19 to determine the electrical capacitance between the electrodes 9 and 10 and from that to ascertain a property or a state of the fluid medium, such as the fill level inside the tank 3. In the same way, the second and the third surface acoustic wave sensors 11 and 13 are also excited using the request signal 30 and a response signal is read out in each case.

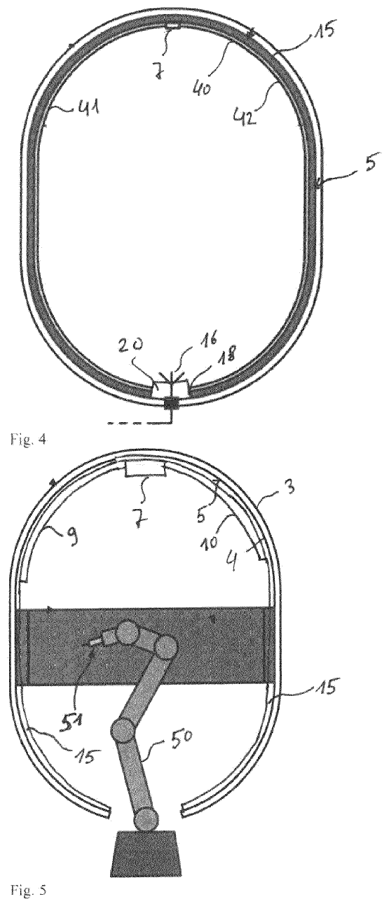

FIG. 3 shows a schematic illustration of a prefabricated integrated sensor band 40 comprising a first electrode 41, a second electrode 42, wherein the electrodes 41 and 42 are electrically connected to the first surface acoustic wave sensor 7 from FIG. 1 and FIG. 2 by means of electrical conductor tracks 8, wherein the two electrodes 41, 42 and the first surface acoustic wave sensor 7 and the conductor tracks 8 are attached on a non-conductive support layer 15, for example made of a film made from Kapton or a glass fiber layer. The prefabricated integrated sensor band 40 can be attached to the internal wall 5 of the tank 3 from FIG. 1 in a simple manner.

FIG. 4 shows a schematic illustration of a sensor band 40 from FIG. 3, comprising the first surface acoustic wave sensor 7, a first electrode 41 and a second electrode 42 on a non-conductive support layer 15 which is attached to an internal wall 5 of the tank capsule 4. The internal antenna 16 is connected through the feed-through opening 18 of the tank capsule 4 to an interrogator, which is not illustrated, wherein the feed-through opening 18 is sealed by means of the seal 20.

FIG. 5 shows a schematic illustration for explaining a production method of the measuring device 1 of FIG. 1 by means of an industrial robot 50, wherein the measuring electrodes 9 and 10 and also the at least one surface acoustic wave sensor 7 are applied fully automatically to the internal wall 5 of the tank capsule 4 of the tank 3 by means of a printing method (functional printing), wherein initially the non-conductive support layer 15 is applied using a surface treatment by means of plasma, laminating on a Kapton film or laminating on a glass fibre layer, wherein a piezoelectric layer for the surface acoustic wave sensor 7 from FIG. 2 is subsequently applied onto this non-conductive support layer 15 and polarized by means of the dispenser 51 on the industrial robot 50, wherein an interdigital transducer (IDT) 32 and/or reflector 35 of the surface acoustic wave sensor 7 from FIG. 2 and also the electrodes 9 and 10 are subsequently applied onto the support layer by means of a conductive paste. Consequently, this production method enables a fully automated integration of the wireless surface acoustic wave sensor 7 and the associated electrodes 9 and 10 on the internal wall 5 of the tank capsule 4.

The invention relates to a measuring device (1) for a fluid medium (2) in an environment (3), comprising at least two electrodes (6), which are arranged in the environment (3) and spaced from one another, which electrodes are set up to measure an electrical capacitance in the intermediate space between them, characterized in that the measuring device (1) additionally comprises at least one surface acoustic wave (SAW) sensor (7, 11, 13), an electrically non-conductive support layer (15), at least one antenna (16) and at least one interrogator, wherein the electrodes (6) are attached on the non-conductive support layer (15), wherein the two electrodes (6) are electrically connected to the surface acoustic wave sensor (7, 11, 13), wherein the antenna (16) is arranged inside the environment (3) and is electrically connected to the interrogator (19) outside the environment (3) by means of an electrical connection (17) through a feed-through opening (18) through an environment capsule (4), wherein a wireless request signal (30) from the interrogator (19) can be transmitted by means of the antenna (16) to the surface acoustic wave sensor (7, 11, 13), wherein the surface acoustic wave sensor (7, 11, 13) can be excited by the request signal (30) and a wireless response signal (38) can be received and transmitted to the interrogator (19) by means of the antenna (16), wherein the response signal (38) can be evaluated by means of the interrogator (19) or a separate evaluation unit in order to measure the electrical capacitance between the electrodes (6) and from that to ascertain at least one property of the fluid medium inside the environment (3).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Measurement device
2 Fluid medium
3 Environment/balance space/for example tank
4 Tank capsule
5 Internal wall/inner side
6 Electrodes
7 First surface acoustic wave sensor
8 Electrical connections
9 First electrode
10 Second electrode
11 Second surface acoustic wave sensor
12 Third electrode
13 Third surface acoustic wave sensor
14 Fourth electrode
15 Non-conductive support layer
16 Antenna
17 Electrical connection
18 Feed-through opening
19 Interrogator
20 Seal
30 Wireless request signal
31 Antenna
32 Interdigital transducer (IDT)
33 Piezoelectric substrate
34 Surface acoustic waves
35 Reflector
36 Response signal
37 Surface acoustic waves
38 Electromagnetic waves
40 Sensor band
41 First electrode
42 Second electrode
50 Industrial robot
51 Dispenser

1.-15. (canceled)

16. A measuring device for detecting at least one property of a fluid medium in an environment, the measuring device comprising:
at least two electrodes, which are arranged in the environment and spaced from one another, the at least two electrodes configured to measure an electrical capacitance in an intermediate space between the at least two electrodes;
at least one surface acoustic wave sensor;
an electrically non-conductive support layer;
at least one antenna; and
at least one interrogator,
wherein the at least two electrodes are attached on the electrically non-conductive support layer,
wherein the at least two electrodes are electrically connected to the at least one surface acoustic wave sensor,
wherein the at least one antenna is arranged inside the environment and is electrically connected to the at least one interrogator outside the environment by an electrical connection through a feed-through opening through an environment capsule,
wherein the antenna is configured to transmit a wireless request signal from the at least one interrogator to the at least one surface acoustic wave sensor,
wherein the at least one surface acoustic wave sensor is configured to be excited by the request signal and the antenna is configured to receive a wireless response signal and transmits the wireless response signal to the at least one interrogator,
wherein the at least one integrator or a separate evaluation unit is configured to evaluate the wireless response signal in order to measure an electrical capacitance between the at least two electrodes and from a measurement to ascertain at least one property of the fluid medium in the environment.

17. The measuring device according to claim 16, wherein a plurality of surface acoustic wave sensors, each having a pair of electrodes, are attached on the electrically non-conductive support layer on an inside of the environment capsule,
wherein the plurality of surface acoustic wave sensors are each configured to be excited by the wireless request signal and to transmit a wireless response signal,
wherein the wireless response signals of the plurality of surface acoustic wave sensors are configured to be evaluated by the interrogator in order to ascertain the at least one property.

18. The measuring device according to claim 17, wherein the pairs of electrodes of the plurality surface acoustic wave sensors are arranged at a specified fill height of the environment,
wherein the wireless response signals of the plurality of surface acoustic wave sensors are configured to be evaluated by the interrogator in order to ascertain a fill level at the specified fill height of the environment.

19. The measuring device according to claim 17, wherein at least two pairs of electrodes of the plurality surface acoustic wave sensors are arranged at least at two different specified fill heights of the environment in order to ascertain a fill level at the two different specified fill heights.

20. The measuring device according to claim 19, wherein a plurality of pairs of electrodes of the plurality surface acoustic wave sensors are arranged at each of the at least two different specified fill heights of the environment.

21. A method for measuring at least one property of a fluid medium in an environment, the method comprising:
providing the measuring device according to claim 16;
transmitting the wireless request signal from the at least one interrogator to the at least one surface acoustic wave sensor by the antenna;
exciting the at least one surface acoustic wave sensor by the request signal;
receiving and transmitting the wireless response signal to the interrogator; and, evaluating the wireless response signal with the interrogator or the separate evaluation unit, in order to ascertain the at least one property of the fluid medium in the environment.

22. The method according to claim 21, further comprising:
arranging a plurality of pairs of electrodes from a plurality of surface acoustic wave sensors at a specified fill height of the environment; and,
evaluating the wireless response signals of the plurality of surface acoustic wave sensors are with the interrogator or the separate evaluation unit in order to ascertain a fill level at the specified fill height of the environment.

23. The method according to claim 23, wherein at least two pairs of electrodes of the plurality of pairs of electrodes are arranged at least at two different specified fill heights of the environment, and
wherein the wireless response signals of the plurality of surface acoustic wave sensors are evaluated by the interrogator or the separate evaluation unit in order to ascertain a fill level at the at least two different specified fill heights.

24. The method according to claim 21, wherein the wireless response signal is influenced by a capacitance value between the at least two electrodes of the at least one surface acoustic wave sensor, so that during a filling of the environment with the fluid medium, the capacitance value between the at least two electrodes is changed by a dielectric constant of the fluid medium that is different compared to a gas located in the environment and consequently, a change of the wireless response signal is evaluated by the interrogator or the separate evaluation unit in order to detect a fill level.

25. A method for producing the measuring device according to claim 16, the method comprising:
applying the at least one surface acoustic wave sensor and the at least two electrodes as at least one prefabricated integrated sensor band on the electrically non-conductive support layer.

26. The method according to claim 25, wherein a plurality of integrated fill level sensor bands are attached at different fill heights on the inside of the environment capsule.

27. The method according to claim 25, wherein the at least one surface acoustic wave sensor, the electrically non-conductive support layer, and the at least two electrodes are printed directly on the inside of the environment capsule by a printing method.

28. The method according to claim 25, wherein the electrically non-conductive support layer is applied by a surface treatment by plasma, by laminating on a film made of polyimide, or by laminating on a glass fiber layer.

29. The method according to claim 25, wherein a piezoelectric layer for the at least one surface acoustic wave sensor is applied onto the electrically non-conductive support layer and polarized by a dispenser of a multi-axis installation,
wherein an interdigital transducer, or a reflector of the at least one surface acoustic wave sensor, or both, and the at least two electrodes are subsequently applied to the electrically non-conductive support layer by a conductive paste.

30. An environment comprising:
the measuring device according to claim 16.
